(19) United States
(12) Patent Application Publication
(10) Pub. No.: US 2017/0036300 A1
(43) Pub. Date: Feb. 9, 2017

(54) MANUFACTURING MACHINE

(71) Applicant: DMG MORI CO., LTD., Yamatokoriyama-shi (JP)

(72) Inventors: Shigeyuki TAKASHIMA, Yamatokoriyama-shi (JP); Yuhei Mezawa, Yamatokoriyama-shi (JP); Makoto Fujishima, Yamatokoriyama-shi (JP)

(73) Assignee: DMG MORI CO., LTD., Yamatokoriyama-shi (JP)

(21) Appl. No.: 15/220,678

(22) Filed: Jul. 27, 2016

(30) Foreign Application Priority Data
Aug. 3, 2015 (JP) 2015-153267

(51) Int. Cl. B23K 26/08; B33Y 50/02; B23K 26/342; B33Y 30/00

(52) U.S. Cl. CPC B23K 26/08; B33Y 30/00; B33Y 50/02; B23K 26/342

(57) ABSTRACT

A manufacturing machine includes: an inert gas supplying device which supplies an inert gas into a machining area to adjust an oxygen concentration of a machining atmosphere; and a control device which controls a condition applied to the inert gas supplying device in supplying the inert gas. The control device includes: a storage unit which stores data about a relationship between a type of a powdery material and an oxygen concentration to be set in the machining area; a control unit which receives a type of a powdery material used for additive manufacturing and checks the type of the powdery material input against the data stored in the storage unit to determine a condition applied to the inert gas supplying device in supplying the inert gas; and a communication unit which indicates the determined condition applied in supplying the inert gas to the inert gas supplying device.

### BACKGROUND OF THE INVENTION

Field of the Invention

The present invention relates to a manufacturing machine and more specifically to a manufacturing machine capable of additive-manufacturing.

Description of the Background Art

Regarding a conventional manufacturing machine, for example, Japanese Patent Laying-Open No. 2004-314168 discloses a laser welding apparatus provided for pumps and intended to rapidly and precisely provide welding without cracking a base material.

The laser welding apparatus disclosed in Japanese Patent Laying-Open No. 2004-314168 has a powder feeder which feeds a metallic material (powder) with argon gas serving as a carrier gas, a cascade powder feeding nozzle which mixes the fed metallic material with the argon gas uniformly and simultaneously uses a gaseous mixture of argon and nitrogen as a shielding gas, and a multiple spindle robot to move the nozzle.

Furthermore, Japanese Patent Laying-Open No. 2012-206137 discloses a repairing apparatus contemplated to facilitate welding without human intervention. The repairing apparatus disclosed in Japanese Patent Laying-Open No. 2012-206137 has a material feeder, a laser device which radiates laser spot light, and a welding robot which moves the laser spot light in directions in three dimensions.

### SUMMARY OF THE INVENTION

One way of attaching a material to provide a workpiece with a three-dimensional form is additive-manufacturing. On the other hand, one way of removing a material to provide a workpiece with a three-dimensional form is subtractive manufacturing. Additive-manufacturing increases the workpiece's mass and subtractive manufacturing decreases the workpiece's mass.

One such additive-manufacturing is directed energy deposition. In directed energy deposition, a powdery material is discharged to a workpiece and the workpiece is irradiated with an energy beam. The additive-manufacturing according to such directed energy deposition has an optimal machining condition varying depending on the type of the powdery material to be used.

Accordingly, an object of the present invention is to solve the above problem, and provide a manufacturing machine which can adjust a machining condition appropriately in additive-manufacturing by directed energy deposition depending on the type of the powdery material to be used.

A manufacturing machine according to the present invention is a manufacturing machine which performs additive-manufacturing by discharging a powdery material to a workpiece and also irradiating the workpiece with an energy beam. The manufacturing machine includes: an inert gas supplying unit supplying an inert gas into a shaping area to adjust an oxygen concentration of a machining atmosphere; and a control device controlling a condition applied to the inert gas supplying unit in supplying the inert gas. The control device includes: a storage unit which stores data about a relationship between a type of a powdery material used in additive-manufacturing and an oxygen concentration to be set in the shaping area; a control unit which receives a type of a powdery material used for additive-manufacturing and checks the type of the powdery material input against the data stored in the storage unit to determine a condition applied to the inert gas supplying unit in supplying the inert gas; and a communication unit which indicates the condition applied in supplying the inert gas determined by the control unit to the inert gas supplying unit.

According to the present invention, a manufacturing machine can be provided that can adjust a machining condition appropriately in additive-manufacturing by directed energy deposition depending on the type of the powdery material to be used.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing a manufacturing machine in an embodiment of the present invention.

FIG. 2 is a perspective view of the manufacturing machine in FIG. 1 in a shaping area in additive-manufacturing.

FIG. 3 shows an additive-manufacturing head attached to a tool spindle.

FIG. 4 is a cross section showing a surface of a workpiece in additive-manufacturing in an enlarged view.

FIG. 5 illustrates a range in which the tool spindle in FIG. 1 swivels.

FIG. 6 is a block diagram representing a mechanism for adjusting an in-machine oxygen concentration in the manufacturing machine in FIG. 1.

FIG. 7 is a table showing an example of data stored in a storage unit in FIG. 6.

FIG. 8 is a perspective view showing an appearance of the manufacturing machine in FIG. 1.

FIG. 9 is a perspective view showing an appearance of a powder feeder installation room in FIG. 8.

FIG. 10 is a perspective view showing an interior of the powder feeder installation room in FIG. 8.

FIG. 11 is a perspective view of a range surrounded by a two dotted line XI in FIG. 10 in an enlarged view.

FIG. 12 is a flow chart showing a flow of adjusting an in-machine oxygen concentration in the manufacturing machine in FIG. 1.

FIG. 13 is a perspective view of a range surrounded by a two dotted line XIII in FIG. 10 in an enlarged view.

FIG. 14 is a diagram showing a hardware configuration of a control device in FIG. 6.

### DESCRIPTION OF THE PREFERRED EMBODIMENTS

Hereinafter reference will be made to the drawings to describe the present invention in embodiments. In the drawings referenced below, the same or corresponding members are denoted by the same numerals.

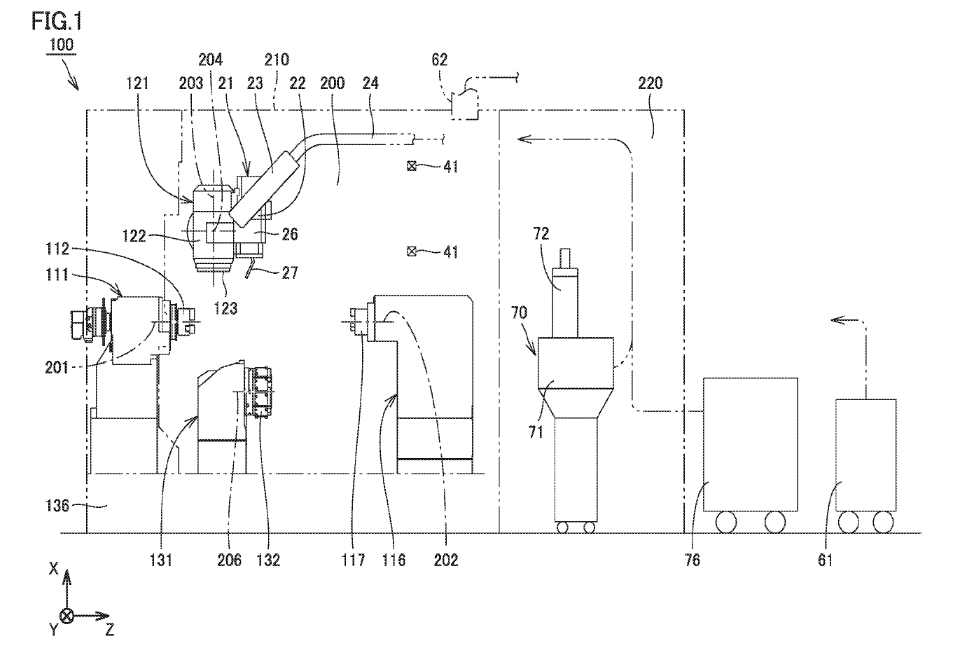

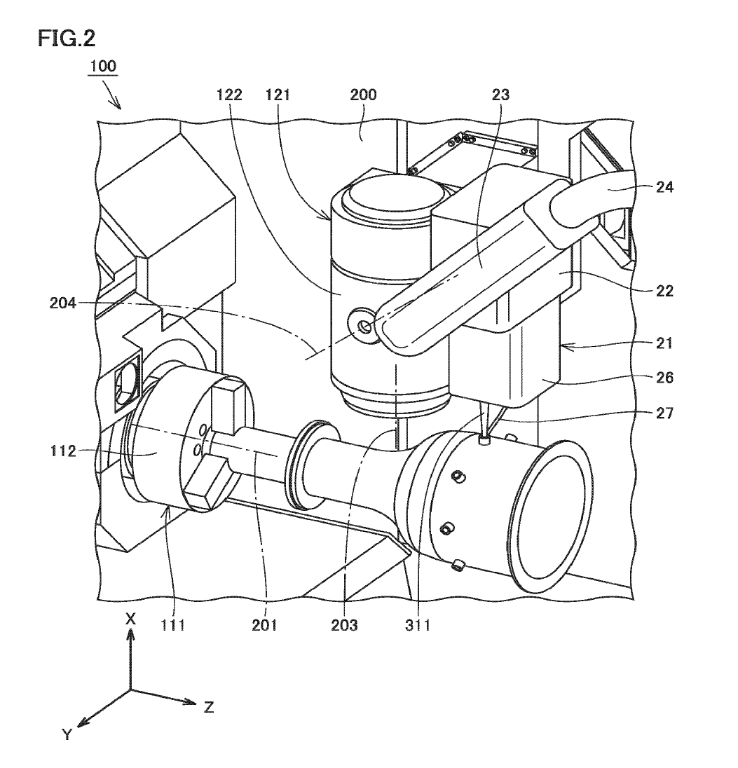

FIG. 1 is a front view showing a manufacturing machine in an embodiment of the present invention. In FIG. 1, a cover body which presents the appearance of the manufacturing machine is shown as if it is transparent, so that the inside of the manufacturing machine is visible. FIG. 2 is a perspective view showing an inside of a shaping area when additive-manufacturing is performed in the manufacturing machine in FIG. 1.

Referring to FIGS. 1 and 2, manufacturing machine 100 is an AM/SM hybrid manufacturing machine capable of additive-manufacturing (AM) for a workpiece and subtractive manufacturing (SM) for a workpiece. Manufacturing machine 100 has a turning function by means of a stationary tool and a milling function by means of a rotary tool, as functions of SM.

First, a description will be given of the overall structure of manufacturing machine 100. Manufacturing machine 100 includes a bed 136, a first headstock 111, a second headstock 116, a tool spindle 121, and a lower tool rest 131.

Bed 136 is a base member for supporting first headstock 111, second headstock 116, tool spindle 121, and lower tool rest 131, and mounted on an installation surface in a factory or the like. First headstock 111, second headstock 116, tool spindle 121, and lower tool rest 131 are provided in a shaping area 200 defined by a splashguard 210.

First headstock 111 and second headstock 116 are provided to face each other in a z-axis direction which extends horizontally. First headstock 111 and second headstock 116 have a first spindle 112 and a second spindle 117, respectively, for rotating a workpiece in a turning process which is performed by means of a stationary tool. First spindle 112 is provided rotatably about a central axis 201 which is in parallel with the z axis. Second spindle 117 is provided rotatably about a central axis 202 which is in parallel with the z axis. First spindle 112 and second spindle 117 are each provided with a chuck mechanism for detachably holding a workpiece.

Second headstock 116 is provided to be movable in the z-axis direction by means of any of various feed mechanisms, guide mechanisms, a servo motor, and the like.

Tool spindle (upper tool rest) 121 causes a rotary tool to rotate in a milling process which is performed by means of the rotary tool. Tool spindle 121 is provided rotatably about a central axis 203 which is in parallel with an x axis extending vertically. Tool spindle 121 is provided with a clamp mechanism for detachably holding the rotary tool.

Tool spindle 121 is supported above bed 136 through a column or the like (not shown). Tool spindle 121 is provided to be movable, by any of various feed mechanisms, guide mechanisms, a servo motor, and the like provided on the column or the like, in the x-axis direction, a y-axis direction which extends horizontally and orthogonally to the z-axis direction, and the z-axis direction. The position of machining by the rotary tool attached to tool spindle 121 moves three-dimensionally. Further, tool spindle 121 is provided to be swivelable about a central axis 204 which is in parallel with the y axis.

Although not shown in FIG. 1, an automatic tool-change device for automatically changing a tool attached to tool spindle 121 and a tool magazine storing replacement tools to be attached tool spindle 121 are provided around first headstock 111.

To lower tool rest 131, a plurality of stationary tools for turning are attached. Lower tool rest 131 has a so-called turret shape, and a plurality of stationary tools are attached radially to lower tool rest 131. Lower tool rest 131 is provided for swivel indexing.

More specifically, lower tool rest 131 includes a swivel unit 132. Swivel unit 132 is provided to be swivelable about a central axis 206 which is in parallel with the z axis. At positions located at intervals in the direction of the circumference centered at central axis 206, tool holders for holding stationary tools are attached. Swivel unit 132 swivels about central axis 206 to thereby circumferentially move the stationary tools held by the tool holders, and a stationary tool to be used for turning is indexed.

Lower tool rest 131 is supported above bed 136 through a saddle or the like (not shown). Lower tool rest 131 is provided to be movable in the x-axis direction and the z-axis direction, by any of various feed mechanisms, guide mechanisms, a servo motor, and the like provided on the saddle or the like.

Manufacturing machine 100 further includes an additive-manufacturing head 21. Additive-manufacturing head 21 performs additive-manufacturing (directed energy deposition) by discharging a powdery material to a workpiece and irradiating the workpiece with an energy beam. As the energy beam, laser light and an electron beam are mentioned representatively. In the present embodiment, additive-manufacturing is done using laser light.

Additive-manufacturing head 21 has a head body (a body) 22, a laser tool (an emission unit) 26, and a cable joint 23.

Laser light and a powdery material are introduced into head body 22. Laser tool 26 emits laser light toward the workpiece and also determines a laser light exposure area of the workpiece. The powdery material introduced into additive-manufacturing head 21 is discharged toward the workpiece via a nozzle unit 27. Cable joint 23 is provided as a joint for connecting to head body 22 a cable 24 described later.

Manufacturing machine 100 further includes a powder feeder 70 serving as a powdery material feeding unit, a laser oscillation device 76, cable 24, an inert gas supplying device 61 as an inert gas supplying unit, and an in-machine oxygen content meter 41.

Powder feeder 70 feeds a powdery material to be used for additive-manufacturing, toward additive-manufacturing head 21 in shaping area 200. Powder feeder 70 is installed in a powder feeder installation room (a room) 220. Powder feeder 70 includes a powder hopper 72 as a tank unit, and a mixing unit 71. Powder hopper 72 forms a closed space for storing the powdery material to be used for additive-manufacturing. Mixing unit 71 mixes the powdery material stored in powder hopper 72 with a carrier gas for the powdery material.

Laser oscillation device 76 generates a laser light to be used for additive-manufacturing. Cable 24 is made up of an optical fiber for guiding the laser light from laser oscillation device 76 toward additive-manufacturing head 21, a piping for guiding the powdery material from powder feeder 70 toward additive-manufacturing head 21, and a tube member which encloses them.

Directed energy deposition which performs additive-manufacturing by discharging a powdery material to a workpiece requires adjusting an oxygen concentration of a machining atmosphere. As a means therefor, manufacturing machine 100 is provided with inert gas supplying device 61 and in-machine oxygen content meter 41.

Inert gas supplying device 61 supplies an inert gas to shaping area 200 via piping 62. As the inert gas, argon and nitrogen are mentioned representatively. Inert gas supplying device 61 has a control valve (not shown) for adjusting a flow rate of the inert gas supplied to shaping area 200. In-machine oxygen content meter 41 detects an oxygen concentration in shaping area 200 (an in-machine oxygen concentration).

Note that although in the present embodiment a space in which an oxygen concentration is adjusted by supplying an inert gas is described as shaping area 200, the present invention is not limited to such a configuration. The space in which an oxygen concentration is adjusted by supplying an inert gas is an area in which the powdery material's dust may rise. For example, the space in which an oxygen concentration is adjusted by supplying an inert gas may reside around a processing point in shaping area 200 or may extend to a space isolated without having hermeticity with shaping area 200.

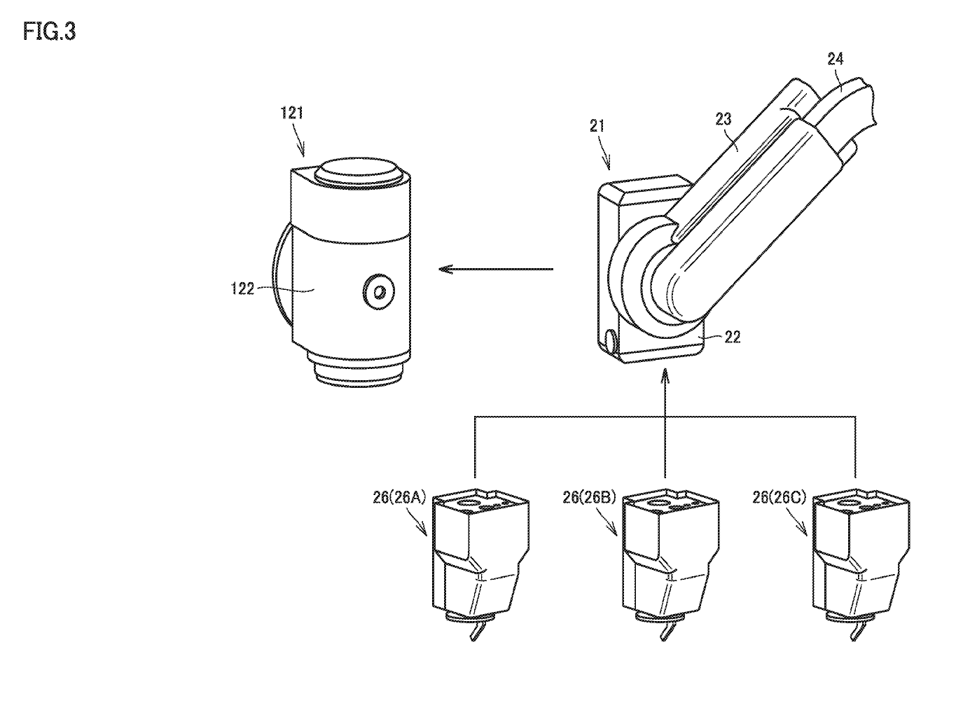

FIG. 3 shows an additive-manufacturing head attached to a tool spindle. With reference to FIGS. 1-3, additive-manufacturing head 21 is provided to be detachably attachable to tool spindle 121. Of additive-manufacturing head 21, head body 22 is provided to be detachably attachable to tool spindle 121.

When additive-manufacturing is performed, additive-manufacturing head 21 is attached to tool spindle 121. Tool spindle 121 moves in the x-axis direction, the y-axis direction, and the z-axis direction to thereby three-dimensionally displace a processing position of additive-manufacturing assumed by additive-manufacturing head 21. When subtractive manufacturing is performed, additive-manufacturing head 21 is separated from tool spindle 121 and stored in a head stocker (not shown).

Tool spindle 121 is provided with a clamp mechanism, and when additive-manufacturing head 21 is attached to tool spindle 121, the clamp mechanism operates to couple additive-manufacturing head 21 to tool spindle 121. An example of the clamp mechanism is a mechanism obtaining a clamping state through a spring force and obtaining an unclamping state through a hydraulic pressure.

Furthermore, in the present embodiment, any one laser tool 26 of a plurality of laser tools 26 (in FIG. 3, a laser tool 26A, a laser tool 26B, and a laser tool 26C) is selectively attached to head body 22 depending on an additive-manufacturing condition to be applied. The plurality of laser tools 26 provide laser light to allow a workpiece to have a region varying in shape, size and the like exposed thereto.

FIG. 4 is a cross section showing a surface of a workpiece in additive-manufacturing in an enlarged view. With reference to FIG. 2 and FIG. 4, in additive-manufacturing, tool spindle 121 having additive-manufacturing head 21 attached thereto is moved and/or first spindle 112 of first headstock 111 holding workpiece 400 is rotated to relatively move additive-manufacturing head 21 and workpiece 400 while causing laser tool 26 to face workpiece 400. At the time, laser light 311, powdery material 312, and gas 313 for shield and carrier are discharged toward workpiece 400 from additive-manufacturing head 21 (laser tool 26). Thus, a melted point 314 is formed on a surface of workpiece 400, and, as a result, powdery material 312 welds.

More specifically, a welding layer 316 is formed in a surface of workpiece 400. On welding layer 316, a welding material 315 is heaped up. When welding material 315 is cooled, it forms a workable layer on the surface of workpiece 400. As the powdery material, any of metal powder of aluminum alloy and magnesium alloy and the like and ceramic powder can be used.

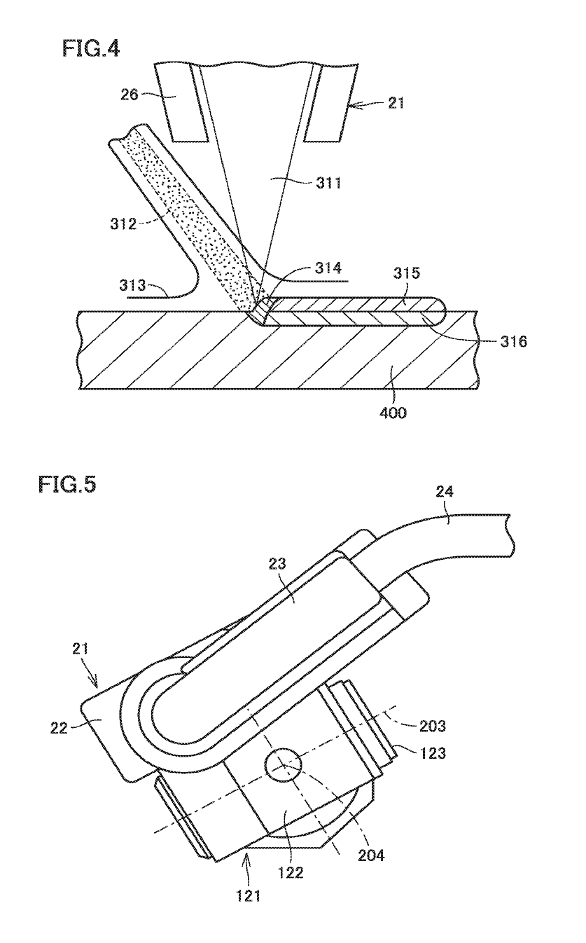

FIG. 5 illustrates a range in which the tool spindle in FIG. 1 swivels. With reference to FIG. 5, tool spindle 121 is provided to be capable of swivel about a central axis 204. Tool spindle 121 swivels in a range of ±120 degrees with reference to a position allowing tool spindle 121 to have a spindle nose facing downward (i.e., a position shown in FIG. 1). FIG. 5 shows tool spindle 121 swiveling by an angle of +120 degrees from the position shown in FIG. 1. Tool spindle 121 swivels in a range preferably of ±90 degrees or more from the position shown in FIG. 1.

In additive-manufacturing performed with additive-manufacturing head 21 attached to tool spindle 121, when tool spindle 121 is swiveled, additive-manufacturing head 21 also swivel together with tool spindle 121. This can change a direction in which additive-manufacturing head 21 performs additive-manufacturing (i.e., a direction in which laser light is directed to the workpiece), as desired.

Subsequently will be described a mechanism in manufacturing machine 100 of FIG. 1 for adjusting an in-machine oxygen concentration.

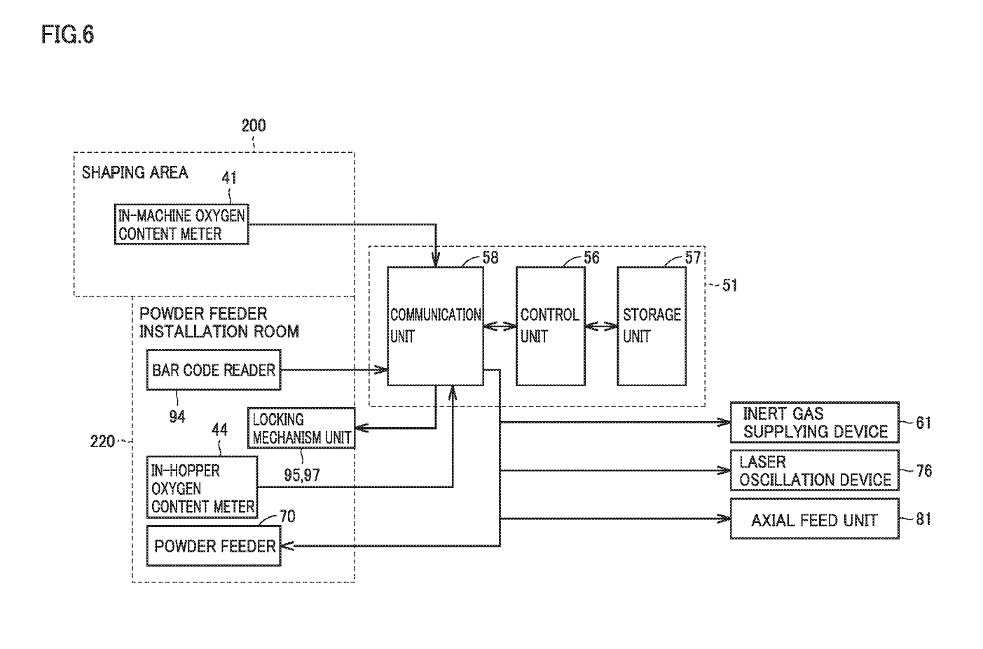

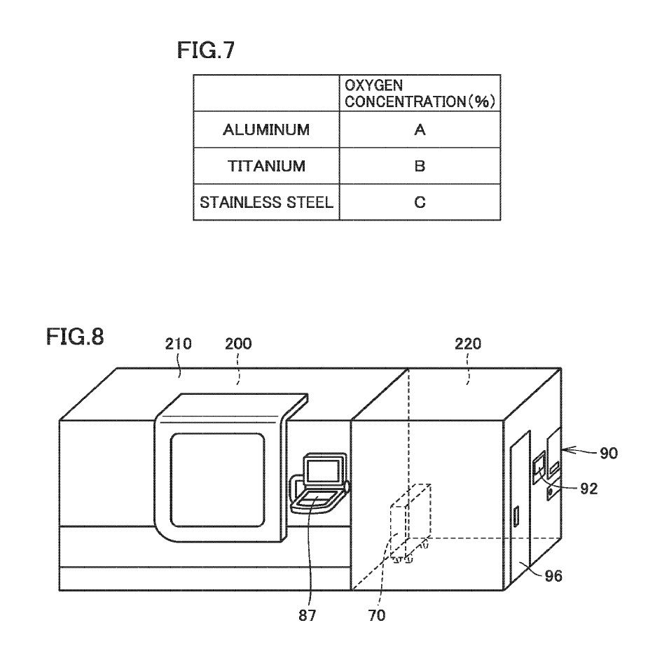

FIG. 6 is a block diagram representing the mechanism in the manufacturing machine in FIG. 1 for adjusting an in-machine oxygen concentration. FIG. 7 is a table showing an example of data stored in a storage unit in FIG. 6.

With reference to FIG. 6 and FIG. 7, manufacturing machine 100 further has a control device 51. Control device 51 is a control console (a control panel) with which manufacturing machine 100 is equipped. Control device 51 controls a condition applied to inert gas supplying device 61 in supplying the inert gas. Control device 51 includes a storage unit 57, a control unit 56, and a communication unit 58.

Storage unit 57 has stored therein data about a relationship between a type of a powdery material used in additive-manufacturing and an oxygen concentration to be set in shaping area 200. For example, in the example shown in FIG. 7, storage unit 57 has stored therein that for powdery materials of aluminum, titanium and stainless steel, oxygen concentrations of A% or less, B% or less, and C% or less, respectively, should be set. Furthermore, for additive-manufacturing performed using a plurality of types of powdery materials mixed together, storage unit 57 may have stored therein an oxygen concentration depending on the mixing ratio.

Furthermore, storage unit 57 has stored therein an association of information of a bar code described later with a type of powdery material.

Control unit 56 receives a type of powdery material used for additive-manufacturing. In the present embodiment, a method which reads a bar code (an identifier) provided on a container of the powdery material is used as a means for inputting a type of powdery material to control unit 56, as will be described later. The means for inputting a type of powdery material is not limited to such a method, and it may for example be a method in which an operator inputs it via a console panel 87 of manufacturing machine 100 (see FIG. 8).

Control unit 56 checks the type of powdery material input against the data stored in storage unit 57 to determine a condition applied to inert gas supplying device 61 in supplying the inert gas. For example, when the type of powdery material input is aluminum, control unit 56 determines a condition applied to inert gas supplying device 61 in supplying the inert gas (in the present embodiment, a degree at which the control valve is opened) such that shaping area 200 has an oxygen concentration of A% or less.

Communication unit 58 indicates the condition applied in supplying the inert gas determined by control unit 56 to inert gas supplying device 61.

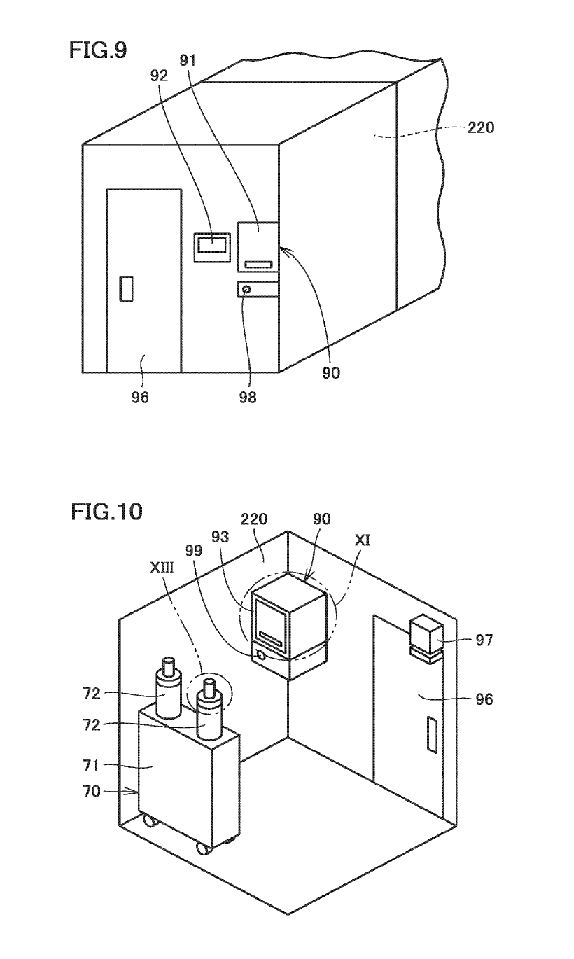

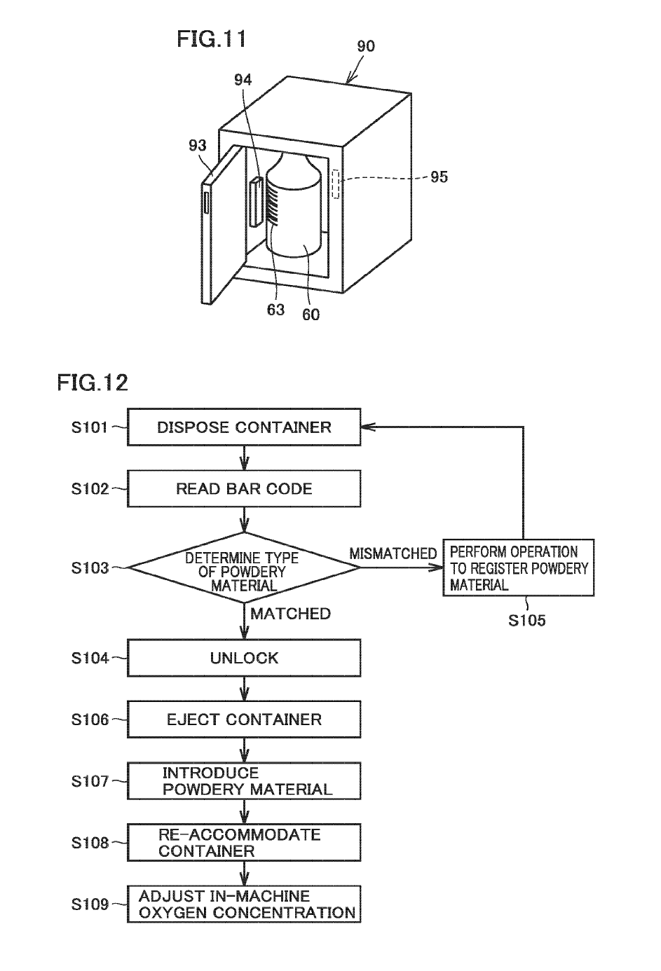

FIG. 8 is a perspective view showing an appearance of the manufacturing machine in FIG. 1. FIG. 9 is a perspective view showing an appearance of the powder feeder installation room in FIG. 8. FIG. 10 is a perspective view showing an interior of the powder feeder installation room in FIG. 8. FIG. 11 is a perspective view of a range surrounded by a two dotted line XI in FIG. 10 in an enlarged view.

With reference to FIG. 6 to FIG. 11, manufacturing machine 100 further has a container accommodation box (a container accommodation unit) 90, an external door 91, an internal door (a door unit) 93, a locking mechanism unit 95, and a bar code reader (a reading unit) 94.

Container accommodation box 90 is provided in powder feeder installation room 220. Container accommodation box 90 is in the form of a casing which can accommodate a container 60 having a powdery material therein.

External door 91 and internal door 93 are provided at container accommodation box 90 such that they can be opened and closed. External door 91 and internal door 93 are provided such that they face an outside and an inside, respectively, of powder feeder installation room 220. When external door 91 is set in an open position, container 60 can be disposed in container accommodation box 90 from outside powder feeder installation room 220. When internal door 93 is set in an open position, container 60 can be extracted from container accommodation box 90 in powder feeder installation room 220.

Locking mechanism unit 95 is provided at internal door 93. Once locking mechanism unit 95 has locked the door, an operation to open internal door 93 is restricted. Once locking mechanism unit 95 has unlocked the door, an operation to open internal door 93 is permitted.

Container 60 is accompanied with a bar code 63. Bar code 63 is provided as an identifier representing the type of a powdery material sealed in container 60. The identifier is not limited to the bar code, and it may for example be a QR Code (registered trademark). Bar code reader 94 is provided inside container accommodation box 90. Bar code reader 94 is configured to be capable of reading bar code 63 accompanying container 60 in a state in which container 60 is accommodated in container accommodation box 90. Manufacturing machine 100 further has a reading start button 98 and an introduction completion button 99. Reading start button 98 is provided outside powder feeder installation room 220. Reading start button 98 is annexed to container accommodation box 90. Introduction completion button 99 is provided inside powder feeder installation room 220. Introduction completion button 99 is annexed to container accommodation box 90.

When reading start button 98 is pressed, communication unit 58 issued a command to bar code reader 94 to start reading bar code 63. When introduction completion button 99 is pressed, control unit 56 recognizes that a powdery material has been introduced into powder feeder 70, and control unit 56 proceeds to a next step.

Manufacturing machine 100 further has a room door (a door unit) 96 and a locking mechanism unit 97. Room door 96 is provided to powder feeder installation room 220. When room door 96 is set in an open position, an operator can enter powder feeder installation room 220. Locking mechanism unit 97 is provided to room door 96. Once locking mechanism unit 97 has locked the door, an operation to open room door 96 is restricted. Once locking mechanism unit 97 has unlocked the door, an operation to open room door 96 is permitted.

FIG. 12 is a flow chart showing a flow of adjusting an in-machine oxygen concentration in the manufacturing machine in FIG. 1.

With reference to FIG. 6 to FIG. 12, initially, container 60 having a powdery material therein is disposed in container accommodation box 90 (S101). More specifically, external door 91 of container accommodation box 90 is opened and container 60 is disposed in container accommodation box 90. External door 91 of container accommodation box 90 is closed.

Then, bar code 63 accompanying container 60 is read (S102). More specifically, reading start button 98 is pressed to cause bar code reader 94 to start reading bar code 63. Information of bar code 63 obtained by bar code reader 94 is transmitted to control unit 56 via communication unit 58. Then, the type of the powdery material is determined (S103). More specifically, control unit 56 checks the information of bar code 63 obtained from bar code reader 94 against the data stored in storage unit 57 and determines the type of the powdery material.

When the type of the powdery material is determined at the step of S103, internal door 93 and room door 96 are unlocked (S104). More specifically, in response to a command to locking mechanism unit 95 from communication unit 58, locking mechanism unit 95 unlocks internal door 93, and an operation to open the door is permitted. In response to a command to locking mechanism unit 97 from communication unit 58, locking mechanism unit 97 unlocks room door 96, and an operation to open the door is permitted.

In contrast, at the step of S103, when the information of bar code 63 is not included in the data stored in storage unit 57, locking mechanism unit 95 keeps locking internal door 93 and locking mechanism unit 97 keeps locking room door 96.

In that case, container 60 has a new type of powdery material therein, and accordingly, a registration operation is required (S105). More specifically, information regarding the new type of powdery material is input via a powder registration screen 92 provided outside powder feeder installation room 220. This registration operation requires previously inputting an ID or the like and can thus be done only by a particular administrator.

After the step of S104, container 60 is extracted from container accommodation box 90 (S106). More specifically, room door 96 unlocked is opened and an operator enters powder feeder installation room 220. Subsequently, internal door 93 unlocked is opened, and container 60 is extracted from container accommodation box 90.

Note that while the present embodiment provides internal door 93 and room door 96 with locking mechanism unit 95 and locking mechanism unit 97, respectively, such a configuration is not exclusive and only one of internal door 93 and room door 96 may be provided with a locking mechanism unit.

Then, the powdery material is introduced into powder feeder 70 (powder hopper 72) from container 60 (S107).

Then, container 60 emptied is again accommodated in container accommodation box 90 (S108). Internal door 93 is closed and introduction completion button 99 is pressed to thus complete introducing the powdery material into powder feeder 70.

Then, the oxygen concentration in shaping area 200 is adjusted (S109). Specially, control unit 56 checks the type of the powdery material determined in step S103 against the data stored in storage unit 57 to determine a condition applied to inert gas supplying device 61 (i.e., a degree at which the control valve is opened) in supplying an inert gas. Communication unit 58 indicates the condition applied in supplying the inert gas determined by control unit 56 to inert gas supplying device 61.

According to such a configuration, a flow rate of an inert gas supplied to shaping area 200 is adjusted depending on the type of a powdery material used in additive-manufacturing, and an in-machine oxygen concentration can be adjusted appropriately.

In doing so, the type of the powdery material can be understood more accurately by determining the type of the powdery material using bar code 63 that accompanies container 60. Furthermore, when container 60 has a new type of powdery material therein, the operator cannot enter powder feeder installation room 220 and cannot extract container 60 from container accommodation box 90. Accordingly, a situation can be avoided in which an in-machine oxygen concentration is not adjusted appropriately as storage unit 57 does not have data stored therein.

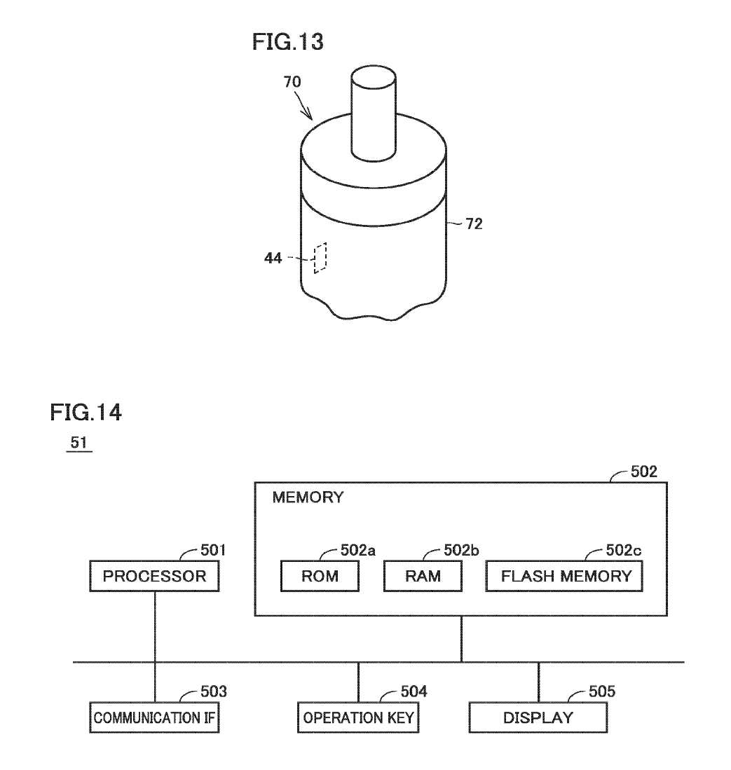

FIG. 13 is a perspective view of a range surrounded by a two dotted line XIII in FIG. 10 in an enlarged view. With reference to FIG. 6 and FIG. 13, manufacturing machine 100 further includes a mechanism which detects that a powdery material is misused, as will be described hereinafter.

Manufacturing machine 100 further has an in-hopper oxygen content meter 44 (an oxygen concentration detection unit). In-hopper oxygen content meter 44 is provided inside powder hopper 72. In-hopper oxygen content meter 44 detects an oxygen concentration inside powder hopper 72 (an in-hopper oxygen concentration).

Powder hopper 72 forms a space which accommodates the powdery material as a sealed space. In that case, as the powdery material's oxidization proceeds, the oxygen concentration in powder hopper 72 varies (or falls) as time elapses. The varying in-hopper oxygen concentration has a profile varying with the type of the powdery material used.

Storage unit 57 has stored therein data about a relationship between a type of a powdery material and a profile of a varying oxygen concentration. An in-hopper oxygen concentration detected by in-hopper oxygen content meter 44 as time elapses is transmitted to control unit 56 via communication unit 58. Control unit 56 checks information of the in-hopper oxygen concentration from in-hopper oxygen content meter 44 against the data stored in storage unit 57 to determine whether the type of the powdery material input to control unit 56 is proper or not.

When control unit 56 determines that the type of the powdery material input to control unit 56 is not proper, control unit 56 may execute a program which compulsorily interrupts additive-manufacturing, issues a warning to the operator, or the like.

According to such a configuration, when container 60 contains a powdery material of a type different from that corresponding to bar code 63, or the like, misuse of the powdery material can be detected.

Storage unit 57 further has stored therein data about a relationship between a type of a powdery material and a condition applied in operating the manufacturing machine in additive-manufacturing. In that case, control unit 56 checks the type of powdery material input against the data stored in storage unit 57 to determine a condition applied in operating manufacturing machine 100 in additive-manufacturing.

the condition applied in operating manufacturing machine 100 in additive-manufacturing includes, for example, a feed rate of additive-manufacturing head 21 (an axial feed unit 81 in FIG. 6), laser light's output (laser oscillation device 76), an amount a powdery material supplied (powder feeder 70), a flow rate of a gas for a carrier of a powdery material (powder feeder 70), and the like.

FIG. 14 is a diagram showing a hardware configuration of a control device in FIG. 6. With reference to FIG. 14, control device 51 includes a processor 501 (typically, a CPU (a central processing unit)), a memory 502, a communication IF (interface) 503, an operation key 504, and a display 505. Memory 502 has a ROM (Read Only Memory) 502a, a RAM (Random Access Memory) 502b, and a flash memory 502c. Components 501-505 are communicatively connected to each other by a bus.

Note that memory 502 may not include flash memory 502c and instead include a writable, other nonvolatile storage medium (for example, an HDD (a Hard Disc Drive)). Alternatively, memory 502 may include, together with flash memory 502c, a writable, other nonvolatile storage medium.

Processor 501 executes a program stored in memory 502. ROM 502a is a nonvolatile storage medium, and, typically, stores BIOS (Basic Input Output System) and firmware. RAM 502b temporarily stores a variety of types of programs, data generated by processor 501 executing a program, and data input by a user. Flash memory 502c has stored therein a body of an NC program, and a program generated by the user.

Note that processor 501 corresponds to control unit 56 in FIG. 6. More specifically, control unit 56 is implemented by processor 501 executing a program stored in memory 502. Memory 502 corresponds to storage unit 57 in FIG. 6. Communication IF 503 corresponds to communication unit 58 in FIG. 6.

Software such as a program stored in memory 502 may be stored in a memory card or another storage medium and distributed as a program product. Alternatively, the software may be provided as a downloadable program product by an information service provider connected to the so-called Internet. Such software is read from the storage medium by a memory card reader writer or another reading device, or alternatively, downloaded via an interface and thereafter temporarily stored to semiconductor memory RAM 502b. The software is read from RAM 502b by processor 501, and furthermore, stored to flash memory 502c in the form of an executable program. Processor 501 executes the program.

Each component configuring control device 51 shown in the figure is a general component. Accordingly, it can also be said that an essential portion of the present invention is software stored in memory 502, a memory card and/or another storage medium, or software downloadable via a network.

Note that a recording medium is not limited to a DVD (Digital Versatile Disc)-ROM, a CD (Compact Disc)-ROM, an FD (Flexible Disk), and a hard disk. For example, it may be a magnetic tape, a cassette tape, an optical disc (MO (Magnetic Optical Disc)/MD (Mini Disc)), an optical card, a mask ROM, an EPROM (Electronically Programmable Read-Only Memory), an EEPROM (Electronically Erasable Programmable Read-Only Memory), a flash ROM or a similar semiconductor memory, or a similar medium bearing a program permanently. Furthermore, the recording medium is a non-transitory medium allowing a computer to read the program and the like therefrom and excludes a transitory medium such as a carrier wave and the like.

Furthermore, a program as referred to herein includes not only a program directly executable by a CPU but also a program in the form of a source program, a compressed program, an encrypted program, and the like.

A program according to the present embodiment controls control device 51 which controls a condition applied to inert gas supplying device 61 in supplying an inert gas. According to an aspect, the program causes processor 501 to perform the steps of: receiving an input of a type of a powdery material used in additive-manufacturing; checking the type of the powdery material input against data stored in memory 502 (more specifically, data about a relationship between a type of a powdery material used in additive-manufacturing and an oxygen concentration to be set in a shaping area) to determine a condition applied to inert gas supplying device 61 in supplying the inert gas; and instructing communication IF 503 to transmit the determined condition to inert gas supplying device 61.

When a structure of manufacturing machine 100 in an embodiment of the present invention described above is summarized, manufacturing machine 100 in the present embodiment is a manufacturing machine which performs additive-manufacturing by discharging a powdery material to a workpiece and also irradiating the workpiece with an energy beam. Manufacturing machine 100 includes: an inert gas supplying device 61 serving as an inert gas supplying unit supplying an inert gas into shaping area 200 to adjust an oxygen concentration of a machining atmosphere; and control device 51 controlling a condition applied to inert gas supplying device 61 in supplying the inert gas. Control device 51 includes: storage unit 57 which stores data about a relationship between a type of a powdery material used in additive-manufacturing and an oxygen concentration to be set in shaping area 200; control unit 56 which receives a type of a powdery material used for additive-manufacturing and checks the type of the powdery material input against the data stored in storage unit 57 to determine a condition applied to inert gas supplying device 61 in supplying the inert gas; and communication unit 58 which indicates the condition applied in supplying the inert gas determined by control unit 56 to inert gas supplying device 61.

Manufacturing machine 100 in an embodiment of the present invention thus configured allows in-machine oxygen concentration to be appropriately adjusted in additive-manufacturing by directed energy deposition depending on the type of the powdery material to be used.

Note that although the present embodiment has been described for manufacturing machine 100 capable of additive-manufacturing and subtractive manufacturing, the present invention is also applicable to a manufacturing machine only capable of additive-manufacturing.

A manufacturing machine according to the present invention is a manufacturing machine which performs additive-manufacturing by discharging a powdery material to a workpiece and also irradiating the workpiece with an energy beam. The manufacturing machine includes: an inert gas supplying unit supplying an inert gas into a shaping area to adjust an oxygen concentration of a machining atmosphere; and a control device controlling a condition applied to the inert gas supplying unit in supplying the inert gas. The control device includes: a storage unit which stores data about a relationship between a type of a powdery material used in additive-manufacturing and an oxygen concentration to be set in the shaping area; a control unit which receives a type of a powdery material used for additive-manufacturing and checks the type of the powdery material input against the data stored in the storage unit to determine a condition applied to the inert gas supplying unit in supplying the inert gas; and a communication unit which indicates the condition applied in supplying the inert gas determined by the control unit to the inert gas supplying unit.

The manufacturing machine thus configured allows an oxygen concentration in a machining atmosphere to be appropriately adjusted depending on the type of the powdery material used in additive-manufacturing. Still preferably, the manufacturing machine further includes: a reading unit which reads an identifier accompanying a container having a powdery material therein and transmits that information to the control unit; and a powdery material feeding unit which receives the powdery material from the container having the identifier read by the reading unit and feeds the powdery material toward an interior of the shaping area. The control unit determines the type of the powdery material based on the information of the identifier received from the reading unit.

The manufacturing machine thus configured allows the control unit to more accurately understand a type of a powdery material used for additive-manufacturing.

Still preferably, the powdery material feeding unit is placed inside a room. The manufacturing machine further includes: a container accommodation unit which is provided inside the room and forms an accommodation space allowing the container to be accommodated therein from outside the room; a door unit which is set in an open position to allow entry into the room and/or allow the container accommodated in the accommodation space to be extracted from inside the room; and a locking mechanism unit which is provided to the door unit and restricts an operation done to open the door unit. The control unit determines whether the type of the powdery material determined is included in the data stored in the storage unit. When the control unit determines that the type of the powdery material is included in the data, the communication unit commands the locking mechanism unit to clear restriction on the operation done to open the door unit.

The manufacturing machine thus configured can prevent a powdery material which is not stored in the storage unit from being introduced into the powdery material feeding unit.

Still preferably, the manufacturing machine further includes: a powdery material feeding unit which has a tank unit forming a sealed space for accommodating the powdery material and feeds toward an interior of the shaping area the powdery material accommodated in the tank unit; and an oxygen concentration detection unit which is provided to the tank unit and detects an oxygen concentration in the sealed space. The storage unit stores data about a relationship between a type of a powdery material accommodated the tank unit and variation of the oxygen concentration in the sealed space with time. The control unit checks an oxygen concentration detected by the oxygen concentration detection unit as time elapses against the data stored in the storage unit to determine whether the type of the powdery material input to the control unit is proper or not.

In the thus configured manufacturing machine when a type of a powdery material input is different from a type of a powdery material actually accommodated in the tank unit of the powdery material feeding unit, the control unit can detect that the powdery material accommodated is misused. Still preferably, the storage unit stores data about a relationship between a type of a powdery material used in additive-manufacturing and a condition applied in operating the manufacturing machine in additive-manufacturing. The control unit checks the type of the powdery material input against the data stored in the storage unit to determine a condition applied in operating the manufacturing machine in additive-manufacturing.

The manufacturing machine thus configured allows a condition applied in operating the manufacturing machine to be appropriately adjusted depending on the type of the powdery material used in additive-manufacturing.

The present invention is mainly applied to a manufacturing machine capable of additive-manufacturing.

While the present invention has been described in embodiments, it should be understood that the embodiments disclosed herein are illustrative and non-restrictive in any respect. The scope of the present invention is defined by the terms of the claims, and is intended to include any modifications within the meaning and scope equivalent to the terms of the claims.

What is claimed is:

1. A manufacturing machine which performs additive manufacturing by discharging a powdery material to a workpiece and also irradiating the workpiece with an energy beam, comprising:
an inert gas supplying unit which supplies an inert gas into a machining area to adjust an oxygen concentration of a machining atmosphere; and
a control device which controls a condition applied to the inert gas supplying unit in supplying the inert gas,
the control device including:
a storage unit which stores data about a relationship between a type of a powdery material used in additive manufacturing and an oxygen concentration to be set in the machining area;
a control unit which receives a type of a powdery material used for additive manufacturing and checks the type of the powdery material input against the data stored in the storage unit to determine a condition applied to the inert gas supplying unit in supplying the inert gas; and
a communication unit which indicates the condition applied in supplying the inert gas determined by the control unit to the inert gas supplying unit.

2. The manufacturing machine according to claim 1, further comprising:
a reading unit which reads an identifier accompanying a container having a powdery material therein and transmits that information to the control unit; and
a powdery material feeding unit which receives the powdery material from the container having the identifier read by the reading unit and feeds the powdery material toward an interior of the machining area, wherein
the control unit determines the type of the powdery material based on the information of the identifier received from the reading unit.

3. The manufacturing machine according to claim 2, the powdery material feeding unit being placed inside a room, the manufacturing machine further comprising:
a container accommodation unit which is provided inside the room and forms an accommodation space allowing the container to be accommodated therein from outside the room;
a door unit which is set in an open position to allow entry into the room and/or allow the container accommodated in the accommodation space to be extracted from inside the room; and
a locking mechanism unit which is provided to the door unit and restricts an operation done to open the door unit, wherein:
the control unit determines whether the type of the powdery material determined is included in the data stored in the storage unit; and
when the control unit determines that the type of the powdery material is included in the data, the communication unit commands the locking mechanism unit to clear restriction on the operation done to open the door unit.

4. The manufacturing machine according to claim 1, further comprising:
a powdery material feeding unit which has a tank unit forming a sealed space for accommodating the powdery material and feeds toward an interior of the machining area the powdery material accommodated in the tank unit; and
an oxygen concentration detection unit which is provided to the tank unit and detects an oxygen concentration in the sealed space, wherein:
the storage unit stores data about a relationship between a type of a powdery material accommodated the tank unit and variation of the oxygen concentration in the sealed space with time; and
the control unit checks an oxygen concentration detected by the oxygen concentration detection unit as time elapses against the data stored in the storage unit to determine whether the type of the powdery material input to the control unit is proper or not.

5. The manufacturing machine according to claim 1, wherein:
the storage unit stores data about a relationship between a type of a powdery material used in additive manufacturing and a condition applied in operating the manufacturing machine in additive manufacturing; and
the control unit checks the type of the powdery material input against the data stored in the storage unit to determine a condition applied in operating the manufacturing machine in additive manufacturing.
